(19) United States
(12) Patent Application Publication
(10) Pub. No.: US 2007/0006818 A1
(43) Pub. Date: Jan. 11, 2007

(54) Animal toy

(76) Inventor: Kimberly K. Bidinger, Houston, TX (US)

Correspondence Address: MICHAEL L. PARKS, Suite 101, 3131 West Alabama, Houston, TX, 77098, US

(21) Appl. No.: 11/177,045

(22) Filed: Jul. 8, 2005

(51) Int. Cl. A01K 29/00

(52) U.S. Cl. 119/709

(57) ABSTRACT

An animal toy for chewing and playing comprising a flexible tube made of chewable material having sufficient thickness for holding its shape and returning to the its shape after chewing with at least one spiral side opening formed axially along the flexible tube to create a helix-like shape along the axial length of the flexible tube for creating a visual barber pole effect and wide enough for providing visual Vs moving axially as the flexible tube is rolled and having different surfaces between the exterior and interior surfaces of the flexible tube to keep animal interest.

### FIELD OF THE INVENTION

This invention relates to the field of animal toys for both interfaces with people and their animals and for animal self-entertainment. The animal toy is made from a flexible tube of a material which is chewable and has sufficient thickness for holding its shape and for returning to its original shape after chewing and being compressed. This tube has at least one spiral side opening formed axially along and through the flexible tube to create a helical-like shape along the axial length of the flexible tube for creating a visual barber pole effect upon rolling. Further, the at least one spiral side opening is wide enough for providing visual Vs to be seen moving axially as the flexible tube is rolled. The at least one spiral side opening of the flexible tube leaves a solid portion of the flexible tube between the at least one spiral side openings and the flexible tube for the creation of an external surface and exposes an interior surface of the flexible tube which has different surfaces from the exterior surface. This exterior surface of the flexible tube may have one texture difference from the interior surface of the flexible tube. In some embodiments, there is at least one color difference between the interior and exterior surfaces of the flexible tube or in some cases there is at least one of the surfaces which is florescent. In yet another embodiment, the different surfaces of the interior and exterior surfaces of the flexible tube comprise a fluffy-like material on the exterior surface of the flexible tube. These animal toys may be made of materials which have sufficient weight for making them throwable and floatable in water to allow the animals to fetch and retrieve these animal toys and prevent their loss.

### BACKGROUND OF THE INVENTION

The prior art animal toys have been directed to ways to hold an animal's interest in their toys. They have provided animal toys which resembled shapes that were thought to be natural to animals, such as tree limb or branch shapes, or bone shapes or rope shapes etc and in some cases these natural shaped toys had foods or scents added which were believed would attract an animal to the animal toy. For example, in cat toys they have added cat nip and in the case of dog toys, foods are provided. However, one of the problems with these toys is that as the foods, flavors, and/or odor of the toy become less strong, the animals lose interest in the toy and the natural shapes do not in and of themselves hold an animals interest or attention.

The problems with animal toys that had scents or foods prepackaged with them is that those foods and scents are consumables and once consumed the toy had no more interest to the animal. To solve this problem, the prior art animal toys had built into them the ability for an animal owner to reinsert new foods and/or new scents by various means such as channels and grooves along the surface or hollowed out centers for providing cavities into which foods or scents could be placed.

The prior art also developed animal toys to re-enforce chewing of animals on their animal toys to promote teeth and jaw development and gentle cleaning of teeth and massaging of gums. In some of these toys for chewing however, the toys were being fully consumed by the animal or the toy was destroyed by the animal. In others, these toys broke up and caused the animal to consume the pieces which resulted in gastrointestinal problems or in some cases fatalities.

Many of the prior art animal toys were designed for only chewing or being thrown by an owner for the animal to retrieve, but in any event the toy in and of itself did not cause an animal to be exercise-active with the toy, unless the owner was actively involved. Because of the busy lifestyles of animal owners, especially those who live in small houses and apartments, there is not enough time and space to exercise their animals, resulting in animals having their needed exercise severely reduced.

Clearly the prior art animal toys relied on man's observations of animals about their interest in food and smells and various shapes, but did not develop vary much in too abstract shapes and motions that had appeal to animals and which stimulated animal to play with their toys on their own. Further, the prior art did not develop much into toys that allowed visual effects to be activated by the animal itself and stimulate the animal to activity and exercise, without the owner's presence.

A further problem with prior art animal toys which used food as the attraction for the toys, was that it tended to over-feed the animals and cause them to gain excessive weight. This weight gain is compounded by the fact that the animals, much like their owners, are not getting enough exercise and the food toys only add to the problem and did not generate sufficient activity to offset the weight gains they produced in the animals.

The prior art animal toys which did try to use abstract shapes and motions did not provide textures, which visually moved in different directions upon motion of the toy to provide animal interest in the toy and which could be activated by the animal. Further, prior art toys which provided abstract shapes and motions did not provide different tactile experiences for the animal as the toy was moved or rolled to again stimulate activity and interest by an animal.

Also, many prior art toys which are used for chewing and fetching could not be used after the animal owner came home from work late in the evening. Not that the animal could not see it, rather the owner had difficulty finding the toy if the animal missed it when it was thrown and many such toys got lost. Furthermore if there was water nearby, many of these animal toys got thrown into the water by accident then the toy sank and would be lost. It also prevented water animals from retrieving the toy from the water.

### OBJECTS OF THIS INVENTION

The object of this invention is to create an animal toy which both interfaces with people and their animals and which provides animal self-entertainment without the use of food or scents. Since this toy does not rely on food or scents to attract and maintain the animal's attention, this novel animal toy has the ability to last for a sustained period of time and provides no need for animal owners to recharge the animal toy with foods or scents by placing them in the animal toy.

A further object of this invention is to develop an animal toy which, because of its unique visual properties and the material from which it is made, reinforces an animal's use of the toy and promote good teeth and jaw development while providing gentle cleaning of the teeth and massaging of the gums. Because of the material from which this animal toy is made, it is virtually impossible for the toy to break up and cause gastrointestinal problems for the animal but because it is inert, even if it does break up, it simply passes through the animal.

Yet another object of this invention is to provide the animal toy for chewing and being thrown by an owner for the animal to retrieve and yet providing a toy which of itself causes an animal to be active with the toy whether the owner is present or not. This feature of active animal involvement, without the owner being required to play with the animal, fits very well with the busy lifestyles of current animal owners who live in small houses and apartments. This active animal involvement, whether an owner is participating or not, helps keep the animal properly exercised even when indoors.

It is a further object of this animal toy to provide abstract shapes and motions that appeal to an animal and stimulate the animal to play with the toy on their own, without the need for providing food and smells and common shapes generally associated with animal toys which are shapes found in nature.

Yet a further object of this animal toy is to use abstract shapes and motion which, when moved, provides textures which move in different directions for providing animal interest in the toy and self-actualization by the animal. These different textures also provide a different tactile experience for the animal as the toy is rolled or moved by the animal's paw.

Still a further object of this invention is to provide a toy which can be used for throwing and fetching in the dark of evening or morning by providing at least one florescent surface to assist the owner in finding the toy after throwing the toy if the dog misses its initial path through the air. While this at least one florescent surface assists the owner in finding the toy, it also provides the animal with changing visual perspective when the toy tumbles through the air.

Still a further object of this toy is to provide the ability for such a toy to float if accidentally or deliberately thrown into water. Since the toy will float and not sink, the owner or animal can retrieve the toy and it not be lost.

Also an object of this invention is to create a helical-like spiral side opening formed axially along the flexible tube to create a helical-like shape along the axial length of the flexible tube for creating a visual barber pole affect upon the flexible tube being rolled, either by the animal or by someone else.

A further object of this invention is that the at least one axial side opening to be wide enough to provide a visual V or series of Vs which will be seen as moving axially as the flexible tube is rolled in either direction to stimulate the animal's visual interest and motivate the animal toward the moving visual V objects of the animal toy.

An object of this invention, also, is that at least one spiral side opening of the flexible tube leaves a solid portion of the flexible tube between the at least one spiral side opening and flexible tube for the creation of an external surface but also exposes the interior surface of the flexible tube. In this invention the exterior surface of the flexible tube may have one texture which is different from the interior surface of the flexible tube. In different embodiments of this invention, the interior and exterior surfaces may be different as to texture and color to enhance the visual impact upon the movement of the visual Vs and the barber pole effect visible to the animal.

In yet other embodiments of this invention, the interior and exterior surfaces may be different, where in the exterior surface of the flexible tube comprises a fluffy-like material on the exterior to increase an animal's interest in the tactile effects of the animal toy invention.

### BRIEF DESCRIPTION OF THE DRAWINGS

The flexible animal toy is made from a flexible tube of material which is chewable and has sufficient thickness for holding its shape and for returning to its original shape after being chewed and being compressed and has at least one spiral side opening formed axially along and through the flexible tube to create a helical-like shape along the axial length of the flexible tube. This helical-like shape creates a visual barber pole effect on rolling and also provides visual Vs which are seen by an animal moving axially as the flexible tube is rolled. This animal toy invention may be practiced in certain physical forms and arrangements and adjustments of the variable parts herein described, but the preferred embodiments of which will be described in detail in the specification and illustrated in the coming drawings which will form a part hereof.

FIG. 1 is a perspective view of the animal toy of this invention showing the flexible tube made of chewable materials having a sufficient thickness for holding it shape and returning to its shape after chewing and being compressed and having at least one spiral side opening along and through the flexible tube

FIG. 2 is a perspective view of the animal toy of this invention showing the flexible tube having at least one spiral side opening with solid portions of the flexible tube between the at least one spiral side opening in the flexible tube forming an exterior surface and an interior surface of the flexible tube which are different from each other. In this perspective view the exterior surface of the flexible tube is composed of a fluffy like material. Also in this perspective view at least one end piece is provided for reinforcing the flexible tube.

FIG. 3 is a side view of the animal toy of this invention showing the flexible tube having at least one spiral side opening of sufficient width to provide a visualV, and a visualV outlined with dashed lines at a first position on the animal toy is shown.

FIG. 4 is a side view of the animal toy of this invention showing the flexible tube having at least one spiral side opening of sufficient width to provide a visualV, and a visualV outlined with dashed lines and at a second position on the animal toy.

FIG. 5 is a side view of the animal toy of this invention showing the flexible tube having at least one spiral side opening of sufficient width to provide a visualV, and a visualV outlined with dashed lines and at a third position on the animal toy.

FIG. 6 is a side view of the animal toy of this invention showing the flexible tube having at least one spiral side opening with solid portions of the flexible tube between the at least one spiral side opening in the flexible tube revealing an exterior surface and an interior surface of the flexible tube which are different from each other.

### DESCRIPTION OF THE PREFERRED EMBODIMENTS

The present invention relates to an animal toy for animal chewing and animal playing with a person or on its own generally referred to at number 10. Referring to FIG. 1 the animal toy 10 of this invention is composed of a flexible tube 11 made of a chewable material having sufficient thickness 12 for holding it shape and returning to that shape after chewing and being compressed by the animal and having at least one spiral side opening 13 formed axially along and through the flexible tube 11. The at least one spiral side opening 13 is sufficiently wide as to form the flexible tube 11 into a helix like shape. Since the at least one spiral side opening 13 runs along the full axial length of the flexible tube 11, a visual barber pole effect is created upon rolling of the flexible tube 11 which creates significant animal interest whether rolled by the owner or caused to be rolled by the animal itself.

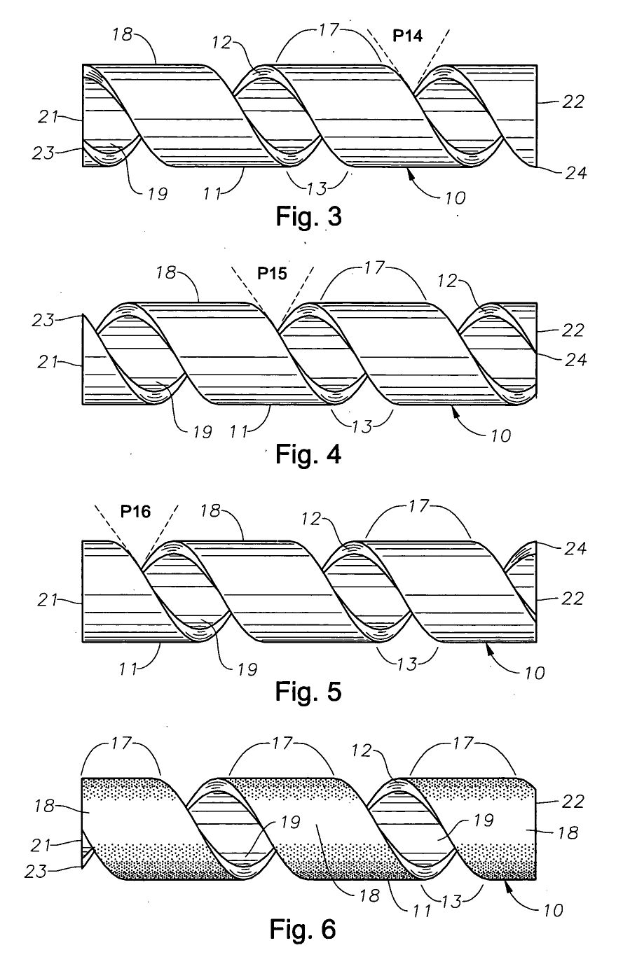

In some embodiments as shown in FIG. 3, FIG. 4, and FIG. 5 the at least one spiral side opening 13 is sufficiently wide to provide in addition to the barber pole effect a visual V which has the effect of moving axially along the at least one flexible tube 11 when the animal toy 10 is rolled. As seen in FIG. 3 a visual V is located at position P14 and as they animal toy 10 is rolled the visualV located at position P14 will be moved to position P15, as seen in FIG. 4, and it will continue to be moved, as shown in FIG. 5, to position P16. It should be appreciated by those skilled in the art that as an animal is close to being in the same plane as the animal toy 10 there is both a barber pole effect and the appearance of visualVs moving all of which provide very dynamic visual effects to the animal. As those skilled in the art would appreciate, most animals are attracted by visual motion, which in the case of this animal toy 10 would be very pronounced whether rolling to or way from the animal.

In yet other embodiments as shown in FIG. 6, a solid portion 17 of the flexible tube 11 is created between the at least one side a spiral side opening 13 as the spiral progresses from one turn to the next along the axial length of the flexible tube 11. As can be visually seen in FIG. 3, FIG. 4, FIG. 5 and FIG. 6 an exterior surface 18 is created, which is visually different from the interior surface 19 of the flexible tube 11. In the case out of FIG. 6 the exterior surface 18 has at least one texture difference from the interior surface 19 which provides both an enhanced visual effect of barber pole and visualV movement. In at least some embodiments as represented in FIG. 6 at least one color difference may be introduced between the exterior surface 18 and the interior surface 19 to again enhance the barber pole affect and the visualV movement.

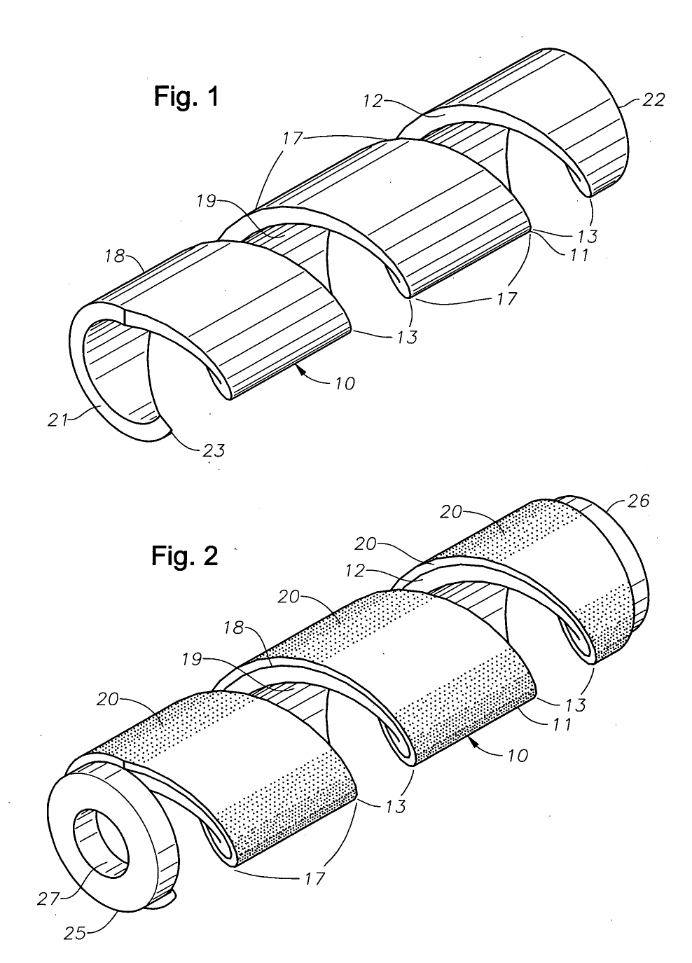

In yet other embodiments of the animal toy 10 the exterior surface 18 as shown in FIG. 2 is provided with at least a fluffy like material 20. In the case of the animal toy 10 which has the at least one fluffy like material 20 located on its exterior surface 18, the animal toy 10 is provided with a tactile experience for the animal in addition to the visual effects.

Those skilled in the art will appreciate that the animal toy 10 may have to be sized and modified for the size of an animal. In the case of the animal toy 10 being used for cats and small dogs the embodiment of FIG. 1 may be adopted which has one open end 21 and another open end 22 which provides significantly more flexibility in the animal toy 10. Because of these open ends 21 and 22, an unsecured end portions 23 and 24 having less material is provided at these points of unsecured end portion to 23 and 24 which provides improved flexibility over the axial length of the animal toy 10. Further by these unsecured end portions 23 and 24 being relatively open they provide sites on the animal toy 10 for animal to get its mouth around for chewing.

However in the case of large animals, such as big dogs, the embodiment of a FIG. 2 might be used. In this embodiment of FIG. 2 an end piece 25 may be provided on the flexible tube 11. In some embodiments also as shown in FIG. 2 another end piece 26 may be provided on the other end of flexible tube 11. The end pieces 25 and 26 may be provided with a hole 27 so that the animal toy 10 is not rendered too inflexible. It should be appreciated by those skilled in the art that some embodiments which have an end piece 25 provided on flexible tube 11 but do not have another end piece 26 would be an embodiment which provides both strength and flexibility to the flexible tube 11 and provides the operative unsecured end portion 24, as in FIGS. 2, 3, & 5, which provides improved flexibility to the animal toy 10. This combination embodiment would provide the benefits of both an end piece 25 and an unsecured end portion 24 being located on the same flexible tube 11 but at opposite ends 21 and 22 of the flexible tube 11. The end piece 25 and/or another end piece 26, if present would provide a grasping points, as those skilled in the art would recognize, for providing an animal owner the ability to throw the animal toy 10. It would be further appreciated by those skilled in the art that as they animal toy is thrown all the features of barber pole and visualV effects would be demonstrated to the animal as the animal toy 10 is flying through the air.

The animal toy 10 of this invention can be made of a rubbery chewable type materials which provide memory before returning to their shape after being chewed or being compressed by being laid upon by the animal. Further the chewable materials may be made such that their composite specific gravity relative to their volume would be sufficient for the flexible animal toy 10 to float in water. Thus such an animal toy would provide water animals with a chance to practice retrieving both from the land and from the water and if the animal toy 10 is thrown into the water by accident an owner would have the ability to retrieve this animal toy 10 and the toy would not be lost. Also by the flexible tube 11 in some embodiments being open on the ends or if having an end piece 25 and/or 26 with a hole 27, as shown in FIG. 2, in it, the animal toy 10 would allow water to drain out of the animal toy 10 after it gets wet.

While the referenced embodiments of the invention of this animal toy has been disclosed it will be appreciated that other embodiments may be used without departing form the sprit of the invention herein claimed.

I claim:

1. An animal toy for animal chewing and for animal playing comprising;
a. a flexible tube for rolling made of chewable material having sufficient thickness for holding its shape and returning to said shape after chewing and being compressed, and
b. at least one spiral side opening formed axially along and through said flexible tube.

2. An animal toy as in claim 1 wherein the at least one spiral side opening formed axially in said flexible tube further comprises;
a. at least one spiral side opening sufficient to open said flexible tube into a helix like shape.

3. An animal toy in claim 2 wherein the at least one spiral side opening into a helix like shape in said flexible tube further comprises;
a. a helix like shape along said full axial length of said flexible tube for creating a visual barber pole effect upon rolling of said flexible tube.

4. An animal toy as in claim 3 wherein the at least one spiral side opening formed into a helix like shape in the flexible tube further comprises;
a. at least one spiral side opening of a width sufficient to provide a visual V for moving axially along said flexible tube when rolling.

5. An animal toy as in claim 4 wherein the flexible tube having the at least one spiral side opening further comprises;
a. solid portions of said flexible tube between said at least one spiral side opening in said flexible tube.

6. An animal toy as in claim 5 wherein the solid portions of said flexible tube between said at least one spiral side opening in said flexible tube further comprises;
a. an exterior surface and
b. an interior surface of said flexible tube which is different from said exterior surface.

7. An animal toy as in claim 6 wherein said exterior surface on said flexible tube having a different surface from said interior surface of said flexible tube further comprises;
a. at least one texture difference between said interior and exterior surfaces of said flexible tube.

8. An animal toy as in claim 6 wherein said exterior surface on said flexible tube having a different surface from said interior surface of said flexible tube further comprises;
a. at least one color difference between said interior and exterior surfaces of said flexible tube.

9. An animal toy as in claim 6 wherein said exterior surface on said flexible tube having a different surface from said interior surface of said flexible tube further comprises;
a. at least one fluffy like material on said, exterior surface of said flexible tube.

10. An animal toy as in claim 8 wherein said exterior surface on said flexible tube having different surface from said Interior surface of said flexible tube further comprises
a. at least one of said interior and exterior surfaces being florescent.

11. An animal toy as in claim 6 wherein said flexible tube having said solid portion between said at least one spiral side opening further comprises,
a. solid portions ending in at least one unsecured open end portion on said ends of said flexible tube.

12. An animal toy as in claim 6 wherein said flexible tube further comprises,
a. at least one end piece on said flexible tube for reinforcing said flexible tube having at least one aperture formed therein.

13. An animal toy as in claim 6 wherein said flexible tube further comprises,
a. materials of sufficient weight for making said animal toy throwable.

14. An animal toy in claim 6 wherein said flexible tube further comprises;
a. materials having their composite specific gravity relative to their volume sufficient for said flexible tube to float in water.
